(19) United States
(12) Patent Application Publication
(10) Pub. No.: US 2002/0024603 A1
(43) Pub. Date: Feb. 28, 2002

(54) Image processing apparatus, method and recording medium for controlling same

(75) Inventors: Tadashi Nakayama, Tokyo (JP); Keita Kimura, Kawasaki-shi (JP); Mayumi Kobayashi, Tokyo (JP)

Correspondence Address: OLIFF & BERRIDGE, PLC, P.O. Box 19928, Alexandria, VA, 22320, US

(73) Assignee: NIKON CORPORATION

(21) Appl. No.: 09/861,591

(22) Filed: May 22, 2001

Related U.S. Application Data
(63) Continuation of application No. 08/942,634, filed on Oct. 2, 1997.

(30) Foreign Application Priority Data
Oct. 2, 1996 (JP) 08-261719
Oct. 2, 1996 (JP) 08-261720
Apr. 1, 1997 (JP) 09-082561
Apr. 1, 1997 (JP) 09-082563

(51) Int. Cl. H04N 5/76

(52) U.S. Cl. 348/232; 348/333.12

(57) ABSTRACT

An image processing control apparatus and method accepts image data and overlay (memo) data stored in memory of an electronic device, such as, for example, an electronic camera, and supplies them to a composing part. In the composing part a composite image of the image data and the overlay data is created. The transmissivity or other composition ratios of the image data and overlay data can be adjusted. The composite image is supplied to memory and is stored in a given area. The resulting composite image is supplied to VRAM, and may be displayed on a display apparatus. A recording medium can store a control program for use by the image processing apparatus to perform the method.

### BACKGROUND OF THE INVENTION

1. Field of Invention

The invention relates to an image processing apparatus, method and recording medium for controlling same, and more particularly to an image processing apparatus, method and recording medium that superimposes and displays image data and overlay line drawing data transferred from an electronic camera, including in a desired transmissivity ratio.

2. Description of Related Art

Recently, instead of film cameras, electronic cameras have been introduced that shoot an image of an object using an electronic CCD detector, convert the image into digital data, and record the digital data in a built-in memory, in a detachable memory card or the like. The image shot using this type of electronic camera can be displayed immediately without chemical development and printing as in conventional cameras, and the image can be shown on an LCD screen or other display.

Many electronic cameras also can transfer the photographed image to a personal computer, display the image on the screen of the personal computer, and store the image on a hard disk or other media.

Some electronic cameras have been configured to display the shot image from the CCD and superimpose drawing data from a transparent touch tablet which allows input of manual line drawing information such as letters and drawings on top of an LCD. The image displayed on the LCD can be observed through the transparent touch tablet, and since the line drawing information input by the touch tablet is displayed on the LCD, it becomes possible to use the LCD and the touch tablet as an electronic viewfinder, as well as an input apparatus for inputting line drawing information.

In electronic cameras equipped this way, provision has been made to transfer the input line drawing information along with the image to a personal computer, and to display them as a composite image on the personal computer screen. By associating the line drawing information with the image, it is possible to record the image and associated line drawing information in electronic memory, hard disk or other media in the personal computer.

However, it is necessary that the line drawing information and image be associated (i.e., inter-related) as two different groups of data, and when the image and the line drawing information are stored separately in memory or on hard disk, this complicates processing as compared to when only a single image is stored.

For instance, it has been a problem that extra memory or hard disk capacity is necessary to store the line drawing information separately from the image.

Moreover, it has not been possible to change the ratio of superimposed image and line drawing information in the composite image, so there has been a problem that a composite image suitable for different uses can not be displayed or recorded.

### SUMMARY OF THE INVENTION

The invention overcoming these and other problems in the art is capable not only of simply retrieving and displaying the image and associated line drawing information which have been previously stored in electronic equipment (e.g., an electronic camera), but also of reducing the capacity of memory or a hard disk when storing the image and associated information in the information processing apparatus (e.g. a personal computer).

According to one embodiment of the invention, an image processing apparatus causes the transfer of a first image and a second image associated with the first image from an electronic device (e.g., an electronic camera) that is coupled to the image processing apparatus. Specifically, a controller causes the first and second images to be transferred from the electronic device to the image processing apparatus via an interface of the image processing apparatus. A first receiving part of the controller can receive the first image. A second receiving part of the controller can receive the second image. The controller then composes the first and second images into a composite image that is capable of being output.

The image processing apparatus preferably includes a memory in which the composite image can be stored. The memory can be random access memory or a hard disk (drive), for example.

The image processing apparatus preferably includes a display on which the composite image can be displayed.

The second image can be a line drawing associated with the first image. When, for example, the electronic device is an electronic camera, the first image can be an image photographed by the electronic camera, while the second image can be a line drawing associated with the first image. The line drawing can be input into the electronic camera, for example, by a touch tablet associated with a liquid crystal display of the electronic camera.

Furthermore, the image processing apparatus can include a setting device for setting composition parameters by which the first image and the second image are composed. The setting device can be a user interface that is provided on a display of the image processing apparatus. The composition parameters can be transmissivities of the first image and the second image. The composite image is composed based on the transmissivity set for the first image and the transmissivity set for the second image.

A recording medium, such as, for example, a CD-ROM can store a control program for use by the image processing apparatus in order to perform the composite image formation process.

### BRIEF DESCRIPTION OF THE DRAWINGS

The invention will be described in conjunction with the following drawings in which like reference numerals designate like elements and wherein:

FIG. 1 is a block diagram illustrating a host computer according to a first illustrative embodiment of the invention, the host computer being coupled to an electronic camera, also shown in block diagram form;

FIG. 2 is a flow chart illustrating the operation of the host computer of FIG. 1;

FIG. 3 illustrates a display of a browser window used in the operation of the invention;

FIGS. 4A-4C illustrate the composite image output process according to the first illustrative embodiment of the invention;

FIG. 5 is a block diagram illustrating a host computer linked to an electronic camera according to a second illustrative embodiment of the present invention;

FIG. 6 is a flow chart illustrating the operation of the host computer of FIG. 5;

FIG. 7 is a flow chart illustrating the composite image output process according to the second illustrative embodiment of the invention;

FIG. 8 is a flow chart illustrating the image receiving process according to the second illustrative embodiment of the invention;

FIG. 9 is a flow chart illustrating the overlay image receiving process according to the second illustrative embodiment of the invention;

FIG. 10 illustrates a display of a setting dialog box for setting image overlay parameters according to the second illustrative embodiment of the invention;

FIG. 11 illustrates different composition ratios of the actual image and the overlay image according to the second illustrative embodiment of the invention; and

FIG. 12 is a flow chart illustrating the composition method of the actual image and the overlay image according to the second illustrative embodiment of the invention.

### DETAILED DESCRIPTION OF PREFERRED EMBODIMENTS

I. First Illustrative Embodiment of the Invention

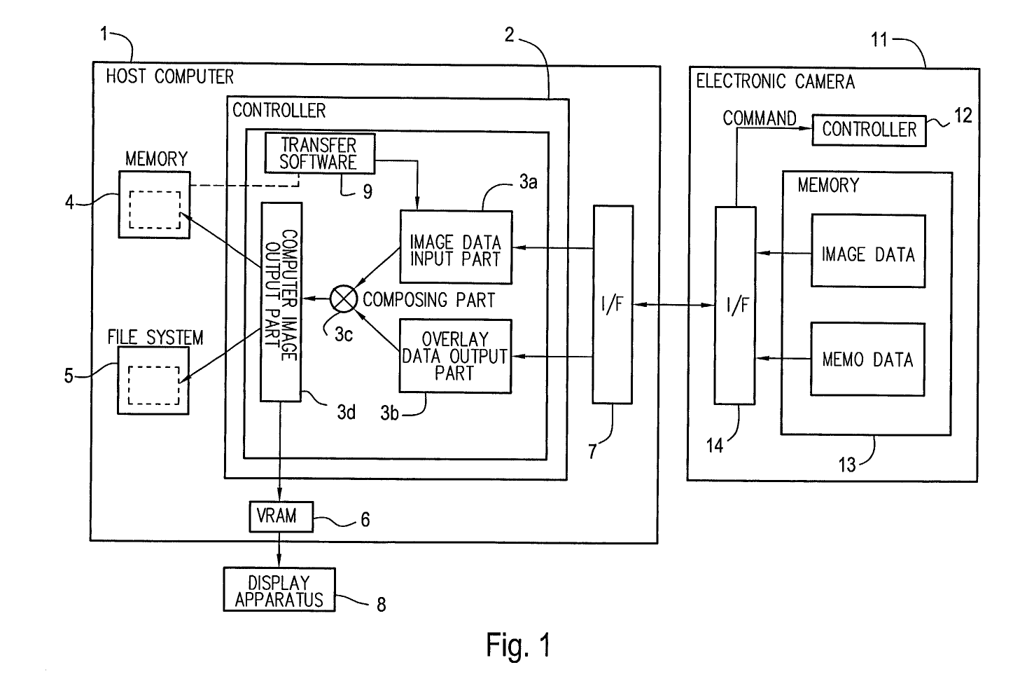

In the operation of the first illustrative embodiment of the apparatus, method and medium of the invention illustrated generally in FIGS. 1-4, an image data input part 3a configures the transfer software 9 and inputs image data transferred via the interface 7 from the electronic camera 11. The overlay image input part 3b inputs overlay data, typically manual line drawing or memo information, transferred via the interface 7 from the electronic camera 11. Composing part 3c composes the image data supplied from the image data input part 3a with the memo data supplied from the overlay image input part 3b, and outputs this composite data to a composite image output part 3d.

Interface 7 controls the transmitting and receiving of control signals (commands) performed between the electronic camera 11 and the host computer 1, and controls the transfer of the image data and the overlay (memo) data.

Memory 4 may be an electronic SRAM or the like. Memory 4 stores the composite image output from the composite image output part 3d. The composite image output part 3d may also output the composite image to file system 5, which can be implemented in a hard disk or other recording media.

VRAM (video RAM) 6 stores bit map data corresponding to the composite image output from the composite image output part 3d, and outputs a control signal corresponding to that bit map data to a display apparatus 8, which operates according to the control signal supplied from VRAM 6 and displays an image corresponding to the bit map data stored in the VRAM 6.

Electronic camera 11 incorporates a controller 12 comprising a CPU, a memory 13 that separately stores the image data corresponding to the photographed image or the overlay data corresponding to the input memo, and an interface 14 that controls the exchange of commands and data between the interface 7 of the host computer 1 and the electronic camera 11.

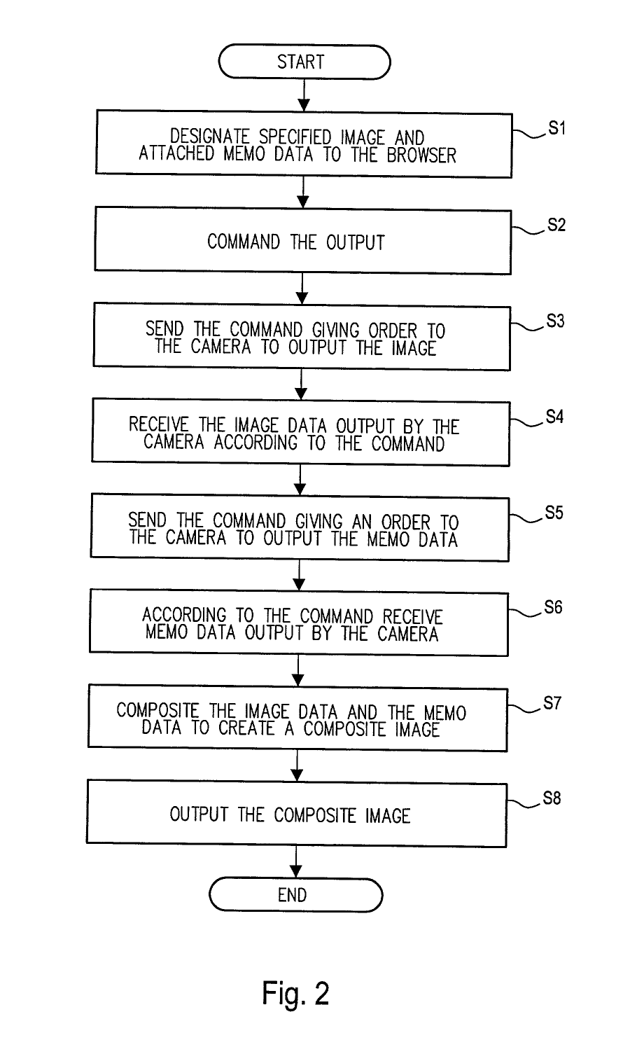

The flow chart of FIG. 2 illustrates the case in which the image data and the overlay data stored in the memory 13 of the electronic camera 11 are transferred to the host computer 1, and stored in the memory 4 or the file system 5.

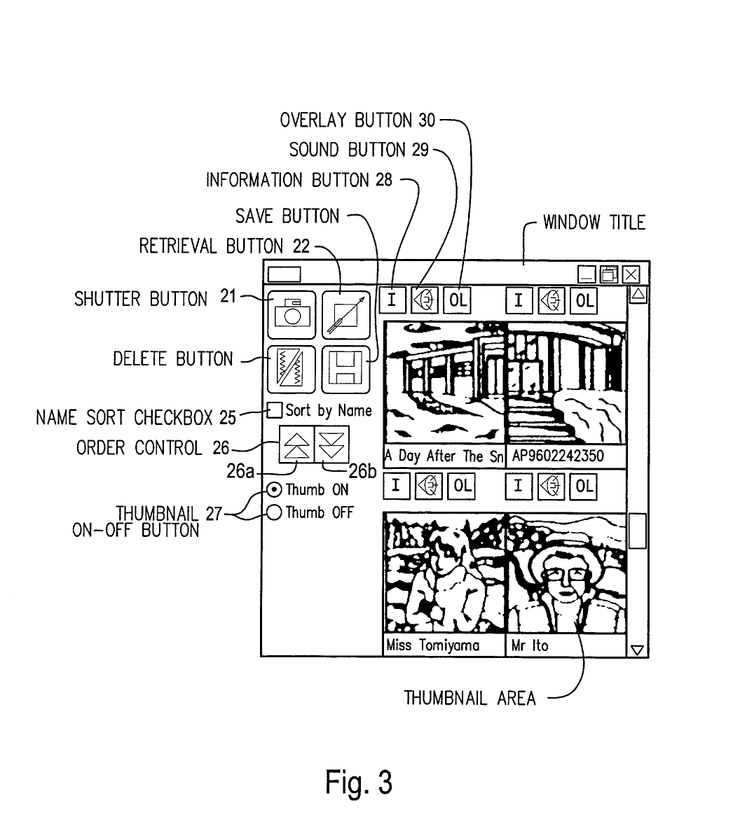

In step S1, the controller 2 supplies display data for the browser window, such as the browser window shown in FIG. 3, to the VRAM 6, and displays this display data on the display apparatus 8. A plurality of thumbnail images (reduced images) are displayed on the browser window, and an information button 28, a sound button 29 and an overlay button 30 are displayed on the top part of the area in which the thumbnail images are displayed. The image name provided to the image in the electronic camera 11 is displayed in the bottom part of the area in which that thumbnail image is displayed. The area in which these buttons, thumbnail images and image name are displayed is called the thumbnail area.

The information button 28 is operated when displaying information corresponding to the viewed image. The sound button 29 is displayed when this image has sound data, and is operated to select the sound data (for example, so that it can be reproduced, saved or deleted). The overlay button 30 is displayed when the image has overlay data, that is, when the image has line drawing information such as overlay data, and is operated to display the overlay data as an overlay to the image.

The shutter button 21 is operated when releasing the shutter (not shown) in the electronic camera 11. The retrieval button 22 is operated when retrieving the image stored by the electronic camera 11 in the memory 13. At this time, the image is retrieved with its original pixel resolution (for example, 640×480 pixels). A delete button 23 is operated to delete an image from the memory 13 of the electronic camera 11. A save button 24 is operated when saving images (for example, from the camera to the host computer). When the name sort check box 25 is checked, the thumbnail images are sorted by alphabetical order using the character string of the image name, and the thumbnail images are displayed in the sorted order.

An order control device 26 comprises two buttons, the proper order button 26A and a reverse order button 26B. This order control device 26 becomes active only when the name by sort check box 25 is checked. Then, the order control device 26 can be operated to designate the order in which image names of the thumbnail images are to be displayed, either the proper order (A to Z in the case of alphabetical order), or reverse.

A thumbnail on/off button 27 is operated to turn thumbnail images on or off. When off is selected, the thumbnail images are deleted, and a list of image names is displayed in place of the thumbnail images.

The user operates a pointing device (not shown) such as a mouse to move the cursor onto the desired thumbnail image. By clicking the mouse button, that thumbnail image is designated; then, by pressing the overlay button 30, the memo data, which is the overlay data related to that thumbnail image, is designated.

Proceeding to step S2 of the flowchart of FIG. 2, the cursor is moved onto the retrieval button 22, and a mouse click on that button designates retrieval of the image and memo designated in step S1.

By doing this, the controller 2 in step S3 supplies a command to the electronic camera 11 via the interface 7 designating image data to be output by the camera. The image data designated is the image data corresponding to the thumbnail image designated in step S1. The interface 14 of the electronic camera 11 delivers the command from the controller 2 of the host computer 1 to the controller 12. The controller 12 reads out the image data corresponding to the designated thumbnail image from the memory 13, according to the command from the controller 12 of the host computer 1, and sends that image data to the host computer 1 via the interface 14.

In step S4, the interface 7 of the host computer 1 receives the image data sent from interface 14 of the electronic camera 11 and supplies that image data to the image data input part 3a.

In step S5, controller 2 supplies a command to be output to the electronic camera 11 via the interface 7. The overlay data designated is the memo data related to the thumbnail image designated in step S1. Interface 14 of the electronic camera 11 delivers the command from the controller 2 of the host computer 1 to the controller 12. The controller 12 reads out the designated overlay data from the memory 13 according to the command from the controller 2 of the host computer 1, and sends that data to the host computer 1 via the interface 14.

In step S6, the interface 7 of the host computer 1 receives the overlay data sent from the interface 14 of the electronic camera 11 and supplies that data to the overlay data input part 3b.

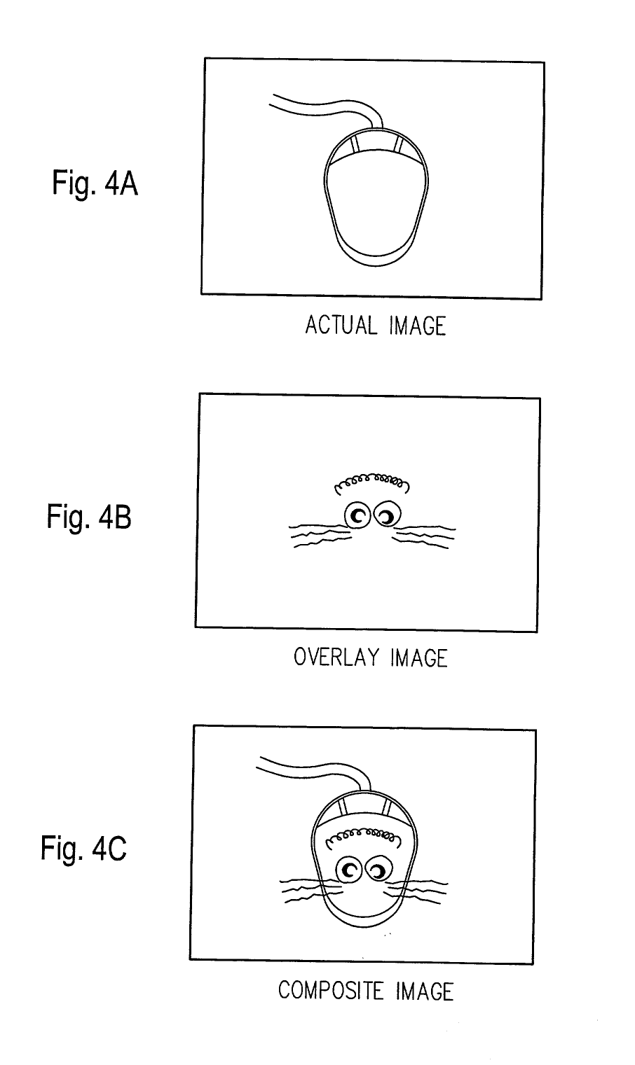

Next, in step S7, the image data input by the image data input part 3a, and the overlay data input by the overlay image input part 3b, are supplied to the composing part 3c and are composed. When image data corresponding to the actual image, such as the one shown in FIG. 4A, is supplied from the image data input part 3a, and overlay data corresponding to the overlay image, such as one shown in FIG. 4B, is supplied from the overlay image input part 3b, composing part 3C operates to create a composite image such as one shown in FIG. 4C.

The image data corresponding to this composite image is supplied to the composite image output part 3d.

Then, the composite image output part 3d transfers and stores the image data corresponding to this composite image to a given area managed by other software in memory 4, thereby transferring and storing the image data to a file system 5. Alternatively or together, the composite image output part 3d transfers the image data to the VRAM 6 and displays the composite image on the display apparatus 8.

In this manner of operation, since the image-data and the overlay data stored separately in the electronic camera 11 are composed and generated as a composite image and the composite image is stored as one file in the host computer 1, the user is able to easily obtain and display a composite image in which the overlay of the memo on the image has already been completed. The image and the overlay data related to that image are often referred to or viewed in this overlaid state. There is little practical inconvenience even if it is saved only as a composite image.

Moreover, memory space in the file system 5 is saved by saving only a composite image in this fashion.

A control program (transfer software) 9 that is used by the controller 2 to perform the process shown in the flow chart in FIG. 2 is stored in the memory 4 or the file system 5 in the host computer 1. This program can be supplied to the user on CD-ROM (compact disk read-only memory) or other media, so that it can be copied to memory 4 or file system 5. When the program is supplied to the user on CD-ROM or the like, the program is copied once to memory 4 or file system 5, then loaded to memory provided in the controller 2. Alternatively, the control program can be loaded from CD-ROM to main memory directly.

While in the first illustrative embodiment described above the composite image is described as being stored in the memory 4 or hard disk 5, the composite image can also be stored in other recording media such as an optical disk or a magnetooptical disk that can be readily removed from the host computer (e.g., via a slot).

Moreover, the transfer software 9 in the preferred embodiment described above can be recorded on a CD-ROM, floppy disk, or any other suitable recording medium.

II. Second Illustrative Embodiment

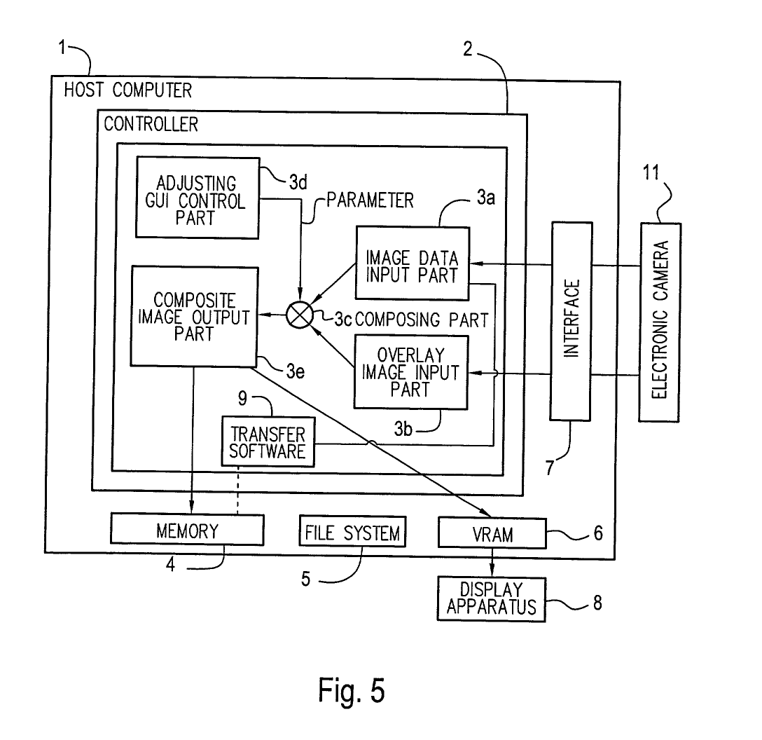

The second illustrative embodiment will be described in the environment of a host computer similar to that of the first illustrative embodiment. The second illustrative embodiment is illustrated generally in FIGS. 5-12. In the host computer 1, the controller 2 includes a CPU which operates according to the transfer software 9, loaded in associated memory 4.

An image data input part 3a which configures the transfer software 9 inputs the image data shot by and transferred from the electronic camera 11, through an interface 7. An overlay image input part 3b inputs the line drawing information such as memo data transferred from the electronic camera 11 through the interface 6. Composing part 3c composes the actual image data supplied from the image data input part 3a and overlay data supplied from overlay image input part 3b.

A GUI (graphical user interface) control part 3d running on host computer 1 is used for adjustment of the composing part 3c. GUI control part 3d displays a setting dialog box or environment for setting the composition ratio when composing the actual image and the overlay image, and supplies parameters corresponding to the composite ratio set by the user to the composing part 3c. Further, the composite image output part 3e outputs a composite image of the actual image data and the overlay image data composed by the composing part 3c.

A file system 5, implemented for instance on a hard disk, stores the composite image output from the composite image output part 3e.

VRAM (video RAM) 6 stores bit map data which corresponds to the composite image output from the composite image output part 3d, and outputs the control signals which correspond to that bit map data. A display apparatus 8 operates according to the control signal supplied from VRAM 6, and displays the image which corresponds to the bit map data stored in VRAM 6.

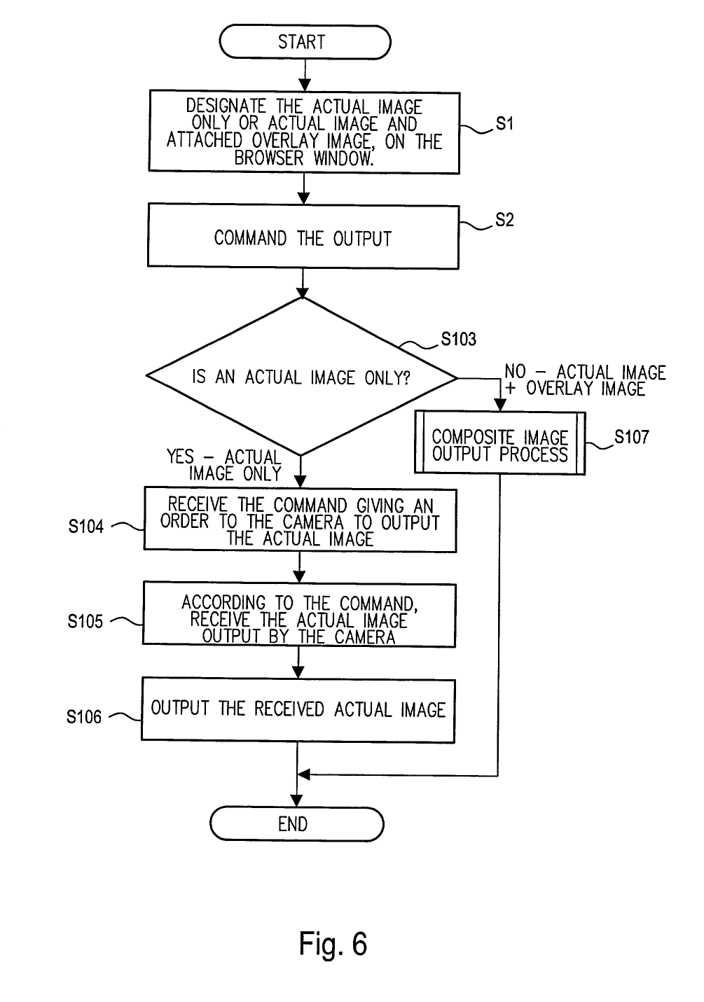

That display operation is executed consistent with the description of the flow chart in FIG. 6. As before, a plurality of thumbnail images (reduced-images) are displayed on the browser window, with an information button 28, a sound button 29 and an overlay button 30 displayed in the top part of the area in which the thumbnail image is displayed.

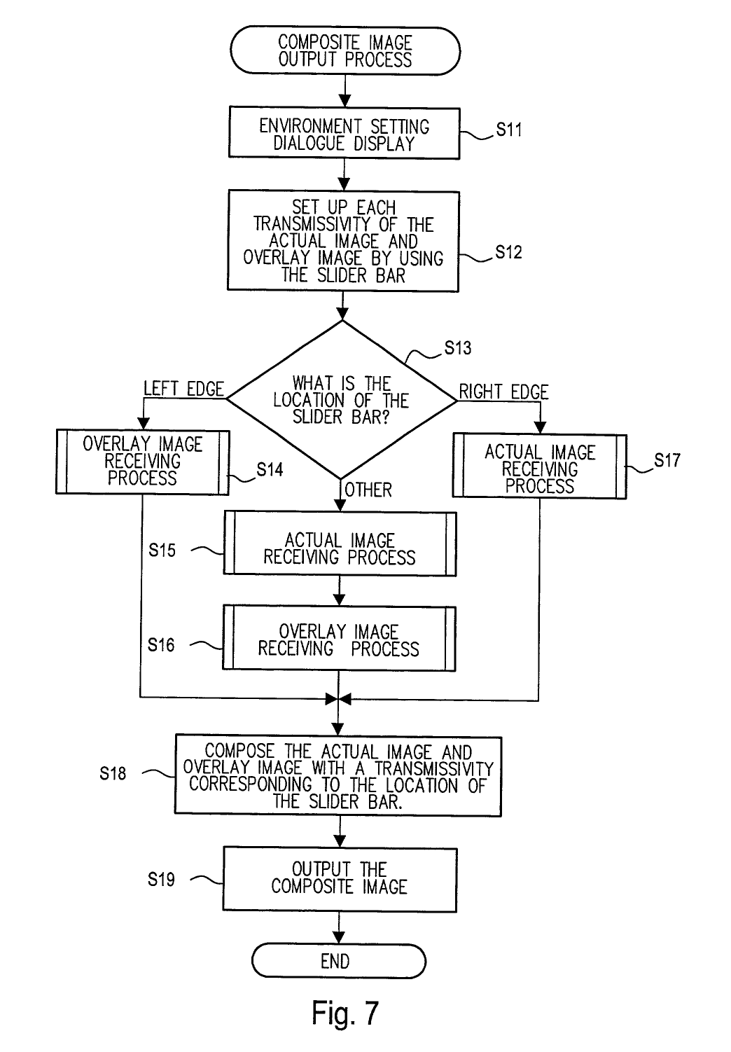

Thumbnail activation, selection and other operations proceed generally as described in the first illustrative embodiment. In step S103 of the flowchart of FIG. 6, when it is determined that the output of the actual image and the overlay image has been designated in step S1(NO), the process proceeds to step S107, the process of composing the actual image and the overlay image is performed, and the composite image is output. The details of the process in step S107 of FIG. 6 are explained with reference to the flowcharts in FIG. 7 and FIG. 9.

Steps S104, S105 and S106 are performed when only the actual image is designated. Steps S104, S105 and S106 are generally similar to steps S3, S4 and S8 of FIG. 2, but only operate on the actual image, as opposed to the composite image.

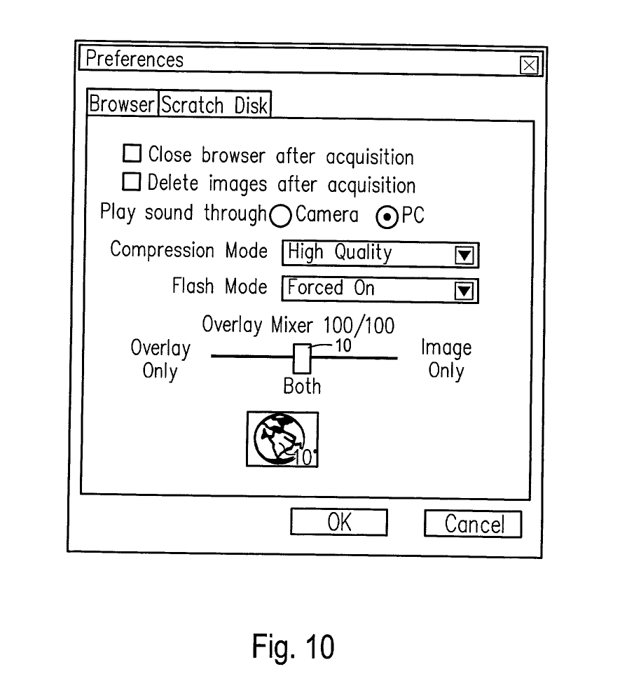

In step S1, the GUI control part 3d supplies bitmap data corresponding to the environment setting dialog box shown in FIG. 10 to the VRAM 6, and displays the bitmap data on the display apparatus 8.

The check box “Close browser after acquisition” of the environment setting dialog box is checked when the retrieval button 22 of the browser window is pressed, and the window is set to close after retrieval of one or more images. The “delete images after acquisition” check box is checked when set to delete the images from the electronic camera 11 after the images have been retrieved.

A compression mode pop-up menu is operated when designating the compression mode of the electronic camera. The selection choices, for example, include “high image quality” and “high compression rate.” A speedlight mode pop-up menu is operated when setting the speedlight mode of the electronic camera 11. The selection choices include, for example, automatic red-eye reduction, forced flash for red-eye reduction, automatic, forced flash and off.

An overlay mixing slider bar 10 is operated when setting the mixing percentage (composition ratio) of the actual image and the overlay image. ‘Image only’ is displayed on the right side of the slider bar 10 and ‘overlay only’ is displayed on the left side of the slider bar. ‘Both’ is displayed in the center of the slider bar 10. Below this, a sample is displayed of the composite image composed of the actual image and the overlay image in the mixed ratio in which the composite image is set at the present time.

Proceeding to step S12, the user uses a mouse or other pointing device (not shown) to operate slider bar 10 provided in the environment setting box, to set the composition ratio of the actual image and the overlay image. In short, the respective transmissivities of the actual image and the overlay image are set. The parameter corresponding to this set value is supplied to the composing part 3c, and used when creating a composite image.

In step S13, the position of the slider bar 10 is detected by the GUI control part 3d and when it is determined that the slider bar is set at the left edge, the process proceeds to step S14, and the process of receiving the overlay image is performed. First, in step S41 (FIG. 9), the controller 2 transmits a command via the interface 6 to order that the overlay image be output. The electronic camera 11 outputs the designated overlay image in accordance with a command transmitted from the host computer 1.

Next, in step S42, the interface 7 of the host computer 1 receives the overlay image sent from the electronic camera 11, and supplies it to the overlay image input part 3b. After this, the process returns to step S18 of FIG. 7.

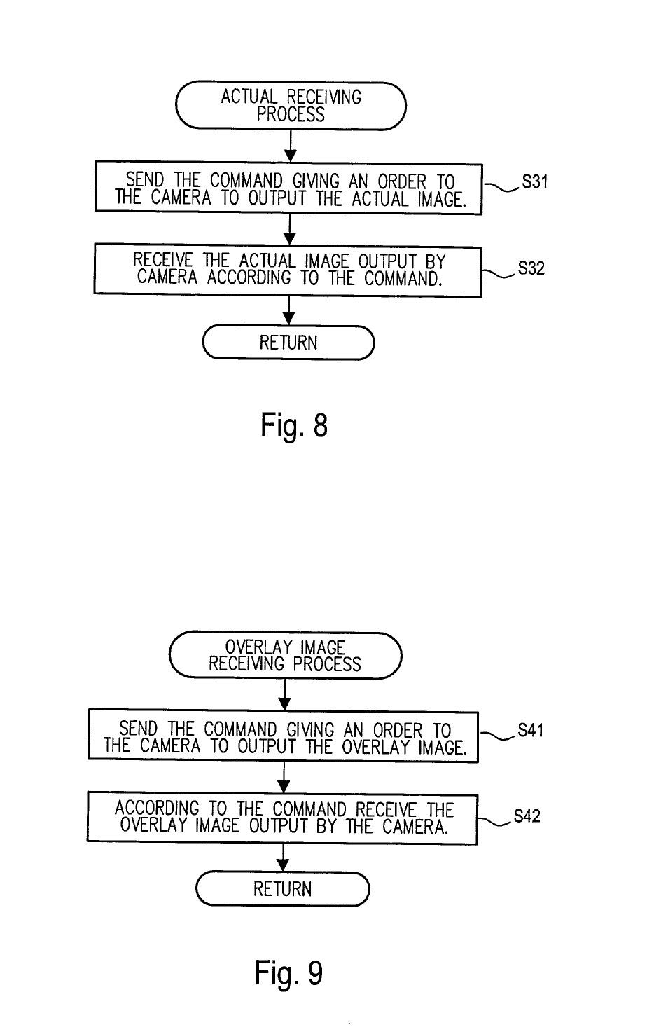

In step S13 of FIG. 7, when it is determined that the slider bar 10 is set at the right end, the process proceeds to step S17, and the actual image receiving process is performed. FIG. 8 is a flow chart detailing the process of receiving the actual image. First, in step S31, the controller 2 transmits a command via the interface 7 to the electronic camera 11 to order the output of the actual image. The electronic camera 11 sends the designated actual (photographed) image to the host computer 1, according to the command transmitted from the host computer 1.

Next, in step S32, the interface 7 of the host computer 1 receives the actual image sent from the electronic camera 11, and supplies it to the actual image input part 3a. After this, the process returns and proceeds to step S18 of FIG. 7.

Moreover, in step S13 of FIG. 7, when it is determined that the slider bar 10 is in another position, the process proceeds to step S15. In step S15, the receiving process of the actual image is performed. Since the steps of this process are the same as in the description of FIG. 8, that explanation is omitted.

When the process of steps S14, S16, and S17 is completed, the process proceeds to step S18. In step S18, the process of composing the actual image and the overlay image is performed by the composing part 3c, with the transmissivity corresponding to the set position of the slider bar 10 of the environment setting dialog box. For example, when the slider bar 10 is set in the center, the actual image and the overlay image are composed with an identical transmissivity of 0. In short, the actual image and the overlay image are mixed with a ratio of 100%.

When the slider bar 10 is set left of center, the mixing ratio of the overlay image is set at 100%, and the mixing ratio of the actual image becomes small, in moving to the left side. When the slider bar 10 is set to the right side from the center, the mixing ratio of the actual image is set at 100%, and the mixing ratio of the overlay image corresponds to the position of the slider bar 10. The composite image composed in this way is supplied to the composite image output part 3e.

In step S19, a composite image is output by the composite image output part 3e. The composite image may be supplied to the memory 4 or file system 5 and stored.

Alternatively or together, it is supplied to the VRAM 6 and displayed on the display apparatus 8.

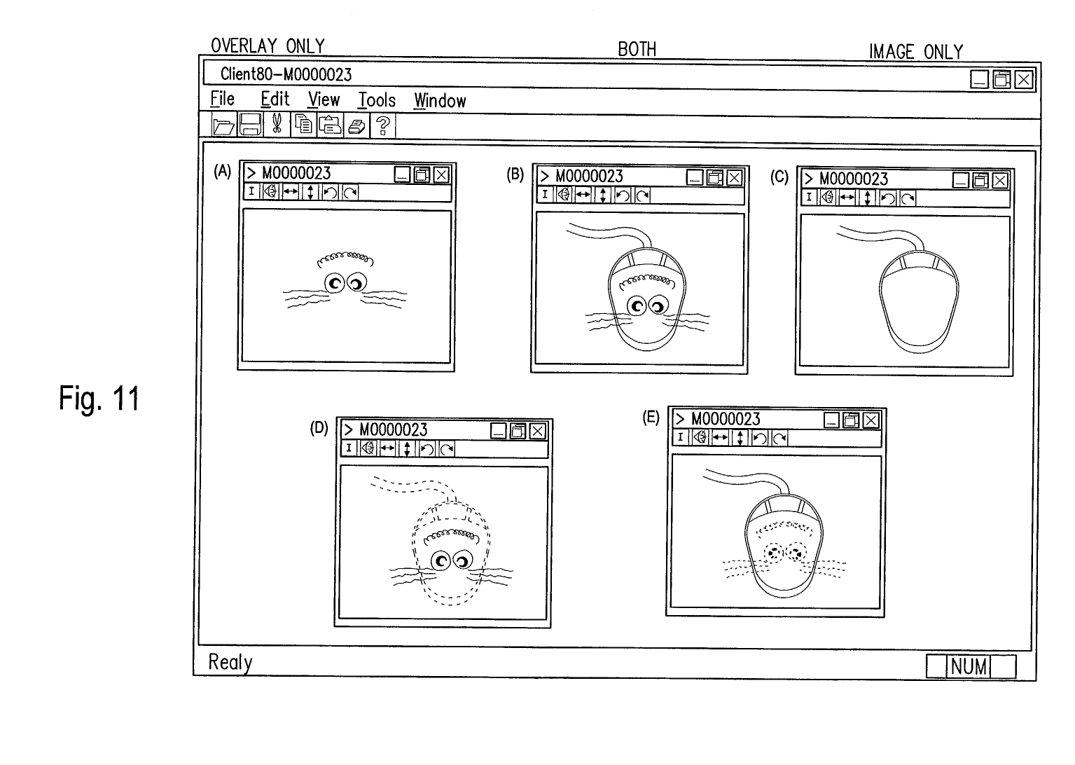

FIG. 11 illustrates examples of different composite ratios of the actual image data and the overlay image data. (A) shows the composite image produced when the slider bar 10 is set at the left end. Only the overlay image is shown, in which the mixing ratio of the overlay image is 100%, and the mixing ratio of the actual image is 0%. (B) shows the composite image when the 10 slider bar 10 is set in the middle. The resulting image is shown in which the actual image is superimposed over the overlay image, with the mixing ratio of the actual image and the overlaid image both set to 100%. (C) shows the composite image when the slider bar 10 is set at the right end. Here, only the actual image is displayed, in which the mixing ratio of the overlay image is 0%, and the mixing ratio of the actual image is 100%. (D) shows the composite image when the slider bar is set left of center. The mixing ratio of the overlay image is 100%, and the mixing ratio of the actual image is a value between 0% and 100%. Thus, the actual image is displayed in the background of the overlay image in a density corresponding to the mixing ratio.

(E) shows the composite image when the slider bar is set right of center in which the mixing ratio overlay image is between 0% and 100%. The mixing ratio of the actual image is 100%, and the overlay image is displayed in a transmissivity corresponding to the mixing ratio.

When the mixing ratio of the actual image is 50% and the mixing ratio of the overlay image is 100%, each pixel is calculated between the value corresponding to 50% of the value of each pixel composing the actual image and the value corresponding to 100% of the value of each pixel composing the overlay image, to define a pixel value of the composite image. For example, a calculation may be performed for each corresponding pixel so that the larger of the pixel values is defined as the pixel value of the composite image. By doing this, for example as in the composite image shown in (D) of FIG. 11, the resulting image exhibits the overlay image clearly, and the background actual image is displayed more faintly.

Conversely, when the mixing ratio of the overlay image is 50%, and the mixing ratio of the actual image is 100%, the pixel value of the composite image is defined by calculating the average value for each pixel corresponding to a value between a value corresponding to 50% of the value of each pixel composing the overlay image and the value corresponding to 100% of each pixel composing the actual image. By doing this, as in the composite image shown in (E) of FIG. 11, the overlay image is displayed in a semi-transparent condition. In the resulting image, it is possible to look through to the actual image that is the background of the overlay image.

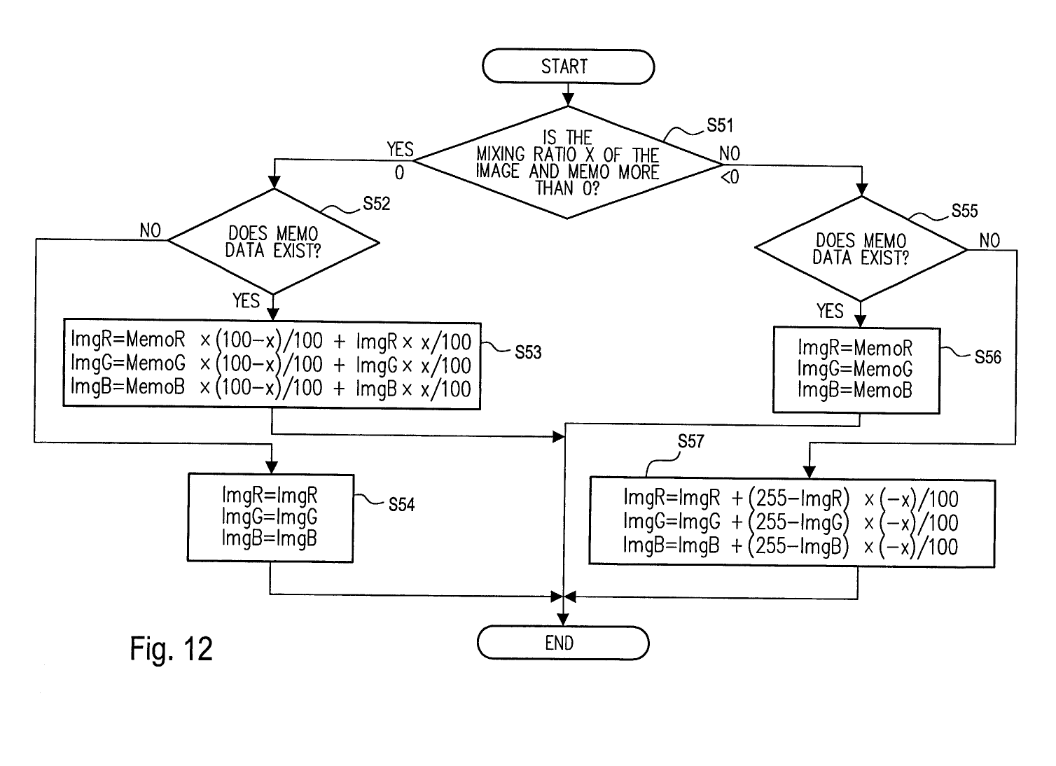

Next, referring to the flow chart of FIG. 12, another method to compose the actual image and the overlay image is explained. Here, each color component of R (red), G (green) and B (blue) consists of 8-bit color image data (actual image), respectively. Overlay data (handwritten memo data) for the same pixel consists of respective 8-bit RGB components as well.

In step S51, it is determined whether the parameter x expressing the mixing ratio of the image and the handwriting memo (overlay) is greater than zero. This parameter x takes values from −100 through 100, and may be set to a given value by operating the slider bar using a mouse. When the slider bar is set in the middle, the value of parameter x is set at 0. When the slider bar is set at the right end, the value of the parameter x is set at 100. When the slider bar is set at the left end, the value of the parameter x is set at −100.

In step S51, when the value of parameter x is greater than 0, the process goes to step S52, and it is determined whether the overlay data is saved. When it is determined that the overlay data is saved, the process proceeds to step S53, and the pixel value ImgR of the R component, the pixel value ImgG of the G component and the pixel value ImgB of the B component that compose the image data are calculated according to the following formula.

Formula 1

Img R=MemoR ×(100−x)/100+ImgR ×x/100

Img G=MemoG ×(100−x)/100+ImgG ×x/100

Img B=MemoB ×(100−x)/100+ImgB ×x/100

In Formula 1 above, MemoR, MemoG and MemoB are expressed as the pixel value of each RGB color component of the memo data.

On the other hand, in step S52, when it is determined that the overlay data has not been saved, the process proceeds to step S54, and according to the formula stated below, each pixel value ImgR of the R component, pixel value ImgG of the G component and the pixel value ImgB of the B component that compose the image data are calculated.

Formula 2

ImgR=ImgR

ImgG=ImgG

ImgB=ImgB

In step S51, when it is determined that the value of the parameter x is less than 0, the process proceeds to step S55, and it is determined whether the overlay data is saved. When it is determined that the overlay data is saved, the process proceeds to step S56, and the pixel value ImgR of the R component, pixel value ImgG of the G component and the pixel value ImgB of the B component which compose the image data are calculated according to the following formula.

Formula 3

ImgR=MemoR

ImgG=MemoG

ImgB=MemoB

On the other hand, in step S55, when it is determined that the overlay data does not exist, the process proceeds to step S57, and the pixel value ImgR of the R component, the pixel value ImgG of the G component and the pixel value ImgB of the B component which compose the image data are calculated according to the following formula.

Formula 4

ImgR=ImgR+(255−ImgR)×(−x)/100

ImgG=ImgG+(255−ImgG)×(−x)/100

ImgB=ImgB+(255−ImgB)×(−x)/100

When steps S53, S54, S56 and S57 are completed, all the processing is completed.

In this way, in the case when the value of parameter x is greater than 0 (0<×<100), the opacity of the overlay image is gradually lowered. During that period, the brightness of the image is not changed. Moreover, when the value of the parameter x is negative (−100<×<0), the opacity of the overlay image is kept at 100%, and the brightness of the image is increased to the extent of the size of the value of parameter x.

As stated above, in the case of displaying the overlay image superimposed over the actual image, it is possible to see through to the actual image directly below the overlay image by changing the transmissivity of the overlay image. Conversely, it is possible to emphasize the overlay image by displaying the actual image as faint. By adjusting these parameters it is possible to freely obtain a composite image with characteristics matching its intended use.

A program in which the controller 2 performs the processing indicated in the flow chart in FIG. 6, FIG. 7, FIG. 8, FIG. 9 and FIG. 12 is stored on the file system 5 in the host computer 1. This program may be previously stored on the file system 5, or stored on CD-ROM (compact disk read-only memory) or other media, and read to the file system 5. As before, when the program is supplied on CD-ROM or the like, the program is copied once onto the file system 5, and loaded to memory 4. Alternatively, the program can be loaded to memory directly from the CD-ROM.

In the illustrative embodiments described above, although the composite image is described as stored on the file system 5 such as a hard disk, it is also possible to store the composite image on other recording media such as optical disk, magnetooptical disk, zip disk or the like.

Although the example provided above related to electronic cameras storing the images and overlay images, such information can be stored on other devices, such as, for example, personal assistants, etc. Additionally, the device from which the image and overlay image data are obtained only needs to be able to store and output such data. It need not be capable of inputting the data as is the case with electronic cameras.

The foregoing description of the invention is illustrative, and variations in construction and implementation will occur to persons skilled in the art. The scope of the invention is intended to be limited only by the following claims.

What is claimed is:

1. An image processing apparatus that is connectable to an electronic device that stores a first image and a second image associated with the first image, the image processing apparatus comprising:
control means for supplying a first control signal to the electronic device to control the transfer of the first image and the second image from the electronic device to the image processing apparatus;
first receiving means for receiving the first image transferred from the electronic device;
second receiving means for receiving the second image transferred from the electronic device; and
composition means for composing the first image and the second image into a composite image that is capable of being output.

2. The image processing apparatus of claim 1, wherein the first image is a photographed image and the second image is a line drawing associated with the first image.

3. The image processing apparatus of claim 1, further comprising memory means for storing the composite image.

4. The image-processing apparatus of claim 3, wherein the memory means is random access memory.

5. The image processing apparatus of claim 3, wherein the memory means is a hard disk.

6. The image processing apparatus of claim 1, further comprising display means for displaying the composite image.

7. The image processing apparatus of claim 1, wherein the electronic device to which the image processing apparatus is connectable is an electronic camera.

8. The image processing apparatus of claim 7, wherein the first image is an image photographed by the electronic camera and the second image is a line drawing associated with the first image.

9. The image processing apparatus of claim 1, wherein the second image is a line drawing associated with the first image.

10. The image processing apparatus of claim 1, further comprising output means for outputting the composite image.

11. The image processing apparatus of claim 1, further comprising setting means for setting composition parameters by which the first image and the second image are composed by the composition means.

12. The image processing apparatus of claim 11, wherein:
the setting means sets a transmissivity of the first image and the second image; and
the composition means composes the first image and the second image based on the transmissivity set by the setting means.

13. The image processing apparatus of claim 12, wherein the setting means changes the transmissivity of one of the first and second images from a pre-set transmissivity, while maintaining the transmissivity of the other of the first and second images at the pre-set transmissivity.

14. The image processing apparatus of claim 12, wherein the control means determines whether the first image and the second image have been transferred based on the transmissivity of the first image and the second image.

15. An image processing apparatus comprising:
an interface that is couplable to an electronic device;
a controller that controls the transfer of a first image and a second image associated with the first image to the interface from an electronic device coupled to the interface, the controller composing the first image and the second image into a composite image that is capable of being output.

16. The image processing apparatus of claim 15, wherein the first image is a photographed image and the second image is a line drawing associated with the first image.

17. The image processing apparatus of claim 15, further comprising a memory, the controller storing the composite image in the memory.

18. The image processing apparatus of claim 17, wherein the memory is random access memory.

19. The image processing apparatus of claim 17, wherein the memory is a hard disk.

20. The image processing apparatus of claim 15, further comprising a display, the controller outputting the composite image to the display.

21. The image processing apparatus of claim 15, wherein the electronic device to which the image processing apparatus is connectable is an electronic camera.

22. The image processing apparatus of claim 21, wherein the first image is an image photographed by the electronic camera and the second image is a line drawing associated with the first image.

23. The image-processing apparatus of claim 15, wherein the second image is a line drawing associated with the first image.

24. The image processing apparatus of claim 15, further comprising:
a setting device that enables a user to set composition parameters by which the first image and the second image are composed by the controller.

25. The image processing apparatus of claim 24, wherein the setting device includes a user interface.

26. A recording medium on which a control program is recorded for use by an image processing apparatus, the control program including:
a first routine that causes the image processing apparatus to transfer a first image and a second image associated with the first image into the image processing apparatus from an electronic device coupled to the image processing apparatus; and
a second routine that composes the first image and the second image into a composite image that is capable of being output.

27. The recording medium of claim 26, wherein the recording medium further includes a third routine that enables a user to set composition parameters by which the first image and the second image are composed.

28. The recording medium of claim 27, wherein the third routine causes the image processing apparatus to generate a user interface through which the composition parameters are set.

29. A method of forming a composite image using an image processing apparatus that is connectable to an electronic device that stores a first image and a second image associated with the first image, comprising the steps of:
transferring the first image and the second image from the electronic device to the image processing apparatus; and
composing the first image and the second image into a composite image in the information processing apparatus.

30. The method of claim 29, wherein the first image is a photographed image and the second image is a line drawing associated with the first image.

31. The method of claim 29, further comprising the step of storing the composite image in a memory.

32. The method of claim 31, wherein the memory is random access memory.

33. The method of claim 31, wherein the memory is a hard disk.

34. The method of claim 29, further comprising the step of setting composition parameters by which the first image and the second image are composed.

35. The method of claim 34, wherein the setting step sets a transmissivity of the first image and of the second image, and the composing step composes the first image and the second image based on the set transmissivity.

36. The method of claim 35, wherein the step of setting the transmissivity includes changing the transmissivity of one of the first image and the second image from a pre-set level, while the transmissivity of the other one of the first image and the second image is maintained at the pre-set level.

37. The method of claim 35, further comprising the step of determining whether the first image and the second image have been transferred based on the transmissivity of the first image and the second image.

38. The method of claim 29, wherein the electronic device is an electronic camera.

39. The method of claim 38, wherein the first image is an image photographed by the electronic camera and the second image is a line drawing associated with the first image.
